(19) United States
(12) Patent Application Publication
(10) Pub. No.: US 2006/0221405 A1
(43) Pub. Date: Oct. 5, 2006

(54) Device management system

(75) Inventor: Keigo Matsumoto, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/264,316

(22) Filed: Oct. 31, 2005

(30) Foreign Application Priority Data
Mar. 31, 2005 (JP) 2005-103732

(51) Int. Cl. H04N 1/00

(52) U.S. Cl. 358/402; 358/448

(57) ABSTRACT

A device management system includes one or a plurality of scanning devices for reading and converting a document image of a contract document, an approval document, a receipt, or the like into electronic form to generate scanned document data; a time-stamping server for adding a time stamp to the scanned document data; a time-stamp counter included in each of the scanning devices for counting the number of times the time stamp is used; a document management server for receiving and storing the time-stamped scanned document data; a control panel for causing one of the scanning devices to perform scanning operation; and an administrative PC connected to each of the scanning devices and collectively managing the number of times the time stamp is used by the scanning devices.

### BACKGROUND OF THE INVENTION

1. Field of the Invention

The present invention relates to document creation and storage techniques in which a document required to be kept is converted into electronic form, given a time stamp, and thus stored. In particular, the present invention relates to a device management system capable of collectively managing the number of times a time stamp is used by each department within an organization when scanned document data in electronic form is given a time stamp and stored, and thus easily managing and sharing costs.

2. Description of the Related Art

Image reading techniques for reading images in a document are applied, for example, to electrophotographic multi-functional peripherals (MFPs) and scanning apparatuses, such as image scanners. There are document management systems that allow images read and converted by such a scanning apparatus into electronic form to be sent to and stored on a document management server or on a PC.

An example of known document management systems of this type is described in JP-A 2001-285534.

This document management system includes an MFP that serves as an image forming apparatus for reading and converting a document image into electronic form. The MFP includes a scanning device that creates scanned document data, including graphics data, from a document image. The scanning device is connected to a LAN and public communication network (WAN), and thus inputs and outputs information.

In addition to the scanning device for converting a document image into electronic form to create scanned document data, the MFP includes a printing device that is capable of printing the created scanned document data on a paper medium.

The printing device includes a print counter for counting the number of sheets printed by operating a PC, and a copy counter for counting the number of copies printed by directly operating the printing device. Associated costs are thus managed.

These days, attention is focused on techniques in which documents required to be kept under legal regulations, and documents required to be kept under company's rules, such as contract documents, approval documents, project proposals, and receipts, are converted into electronic form, and scanned document data in electronic form is given an electronic signature and time stamp and stored in a document management server.

To add an electronic signature and time stamp to scanned document data, an organization, such as a company, makes licensing agreements with a certificate authority and timing authority. Then, only when given permission, the organization (company) has access to the certificate authority and timing authority, and thus can receive an electronic signature and time stamp therefrom.

Generally, in electronic signature systems currently available, a package agreement for a specified duration is made to receive an electronic signature. In this case, since costs remain unchanged regardless of the number of times the electronic signature is received within the duration of the agreement, there is no need to count the number of times the electronic signature is received by each department of an organization and to perform cost management.

On the other hand, in time stamping systems, a usage fee is charged every time a time stamp is used under an agreement. Therefore, managing the number of times a time stamp is received by each department within an organization is important in purchasing time stamp licenses and performing cost management. For example, a time stamp license limits the number of times a licensee can use the time stamp to 10000 times. Therefore, if the maximum number of times the time stamp can be used has been exceeded, the licensee becomes no longer able to receive the time stamp unless the licensing agreement is renewed.

In a known MFP with a scanning device and printing device, when scanned document data created by the scanning device or document data, including graphics data, from a PC is printed by the printing device, the number of copies and the number of printed sheets are counted by a copy counter and a print counter, respectively, and for a plurality of MFPs are individually managed in each MFP.

However, since each MFP does not have a time-stamp counter, the number of times a time stamp is used in each department of an organization is counted on an individual basis. It is thus difficult for administrators to intensively and collectively manage the number of times the time stamp is used in each department, and to collectively manage costs associated with the use of the time stamp.

### SUMMARY OF THE INVENTION

The present invention has been achieved in view of the circumstances described above. An object of the present invention is to provide a device management system that includes time-stamp counters, and thus is capable of managing the number of times a time stamp is used in each department of an organization while collectively managing the total number of times the time stamp is used in the entire organization, thereby managing costs and time stamp licenses easily and in a timely manner.

To solve the problems described above, in an aspect of the present invention, a device management system includes one or a plurality of scanning devices for reading and converting a document image of a contract document, an approval document, a receipt, or the like into electronic form to generate scanned document data; a time-stamping server for adding a time stamp to the scanned document data; a time-stamp counter included in each of the scanning devices for counting the number of times the time stamp is used; a document management server for receiving and storing the time-stamped scanned document data; a control panel for causing one of the scanning devices to perform scanning operation; and an administrative PC connected to each of the scanning devices and collectively managing the number of times the time stamp is used by the scanning devices.

The device management system of the present invention includes a plurality of scanning devices each having a time-stamp counter for counting the number of times a time stamp provided by a timing authority (or, time-stamping server) is used. At the same time, values counted by the time-stamp counters are collected and collectively managed by an administrative PC. Since the administrative PC can manage the number of times a time stamp is used in each scanning device while managing the number of times the time stamp is used in all the scanning devices quickly and easily, cost sharing among departments within an organization and the number of remaining licenses can be managed smoothly and automatically.

### BRIEF DESCRIPTION OF THE DRAWINGS

FIG. 1 shows the system structure of a device management system according to an embodiment of the present invention.

FIG. 2 shows the structure of a controller for controlling a scanning device of the device management system.

FIG. 3 shows an administrative PC capable of collectively managing the counts of each counter in a scanning device of an MFP.

FIG. 4 is a flowchart showing a process of adding a time stamp to scanned document data in the device management system.

### DESCRIPTION OF THE PREFERRED EMBODIMENTS

Embodiments of a device management system according to the present invention will now be described with reference to the attached drawings.

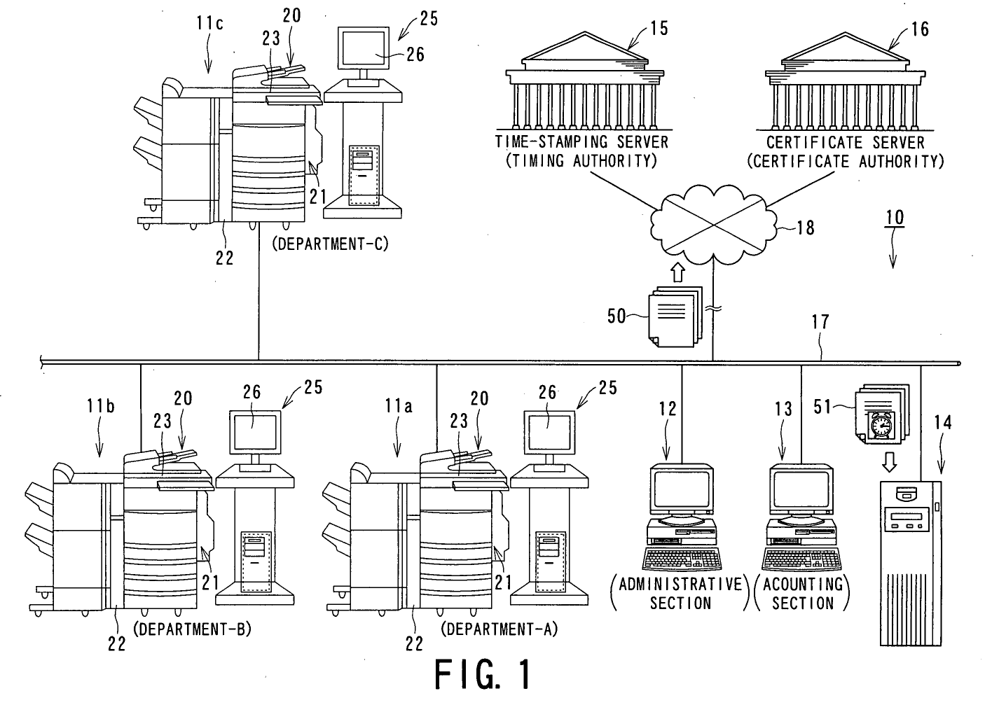

FIG. 1 shows the system structure of a device management system according to an embodiment of the present invention. A device management system 10 includes one or a plurality of MFPs 11 (11a, 11b, and 11c), an administrative PC 12, an accounting PC 13, a document management server 14, a time-stamping server 15 serving as a timing authority, and an electronic signature server 16 serving as a certificate authority that are connected through a system bus 17 via a LAN, or via a communication network 18, such as the Internet. The one or plurality of MFPs 11 (11a, 11b, and 11c) are installed, for example, in a company including departments A, B, and C.

Each of the MFPs 11 (11a, 11b, and 11c) includes a scanning device 20 and a printing device 21 in the upper and lower parts of a main casing 22, respectively. The scanning device 20 reads and converts a document image into electronic form, while the printing device 21 prints the scanned document data, including graphics data, on a paper medium. A control panel 23 for controlling the entire MFP 11 is provided on top of the main casing 22. The scanning device 20 and the printing device 21 operate independently or in conjunction with each other by operating the control panel 23. The MFP 11 may be replaced with a digital copier or a scanning apparatus, such as an image scanner.

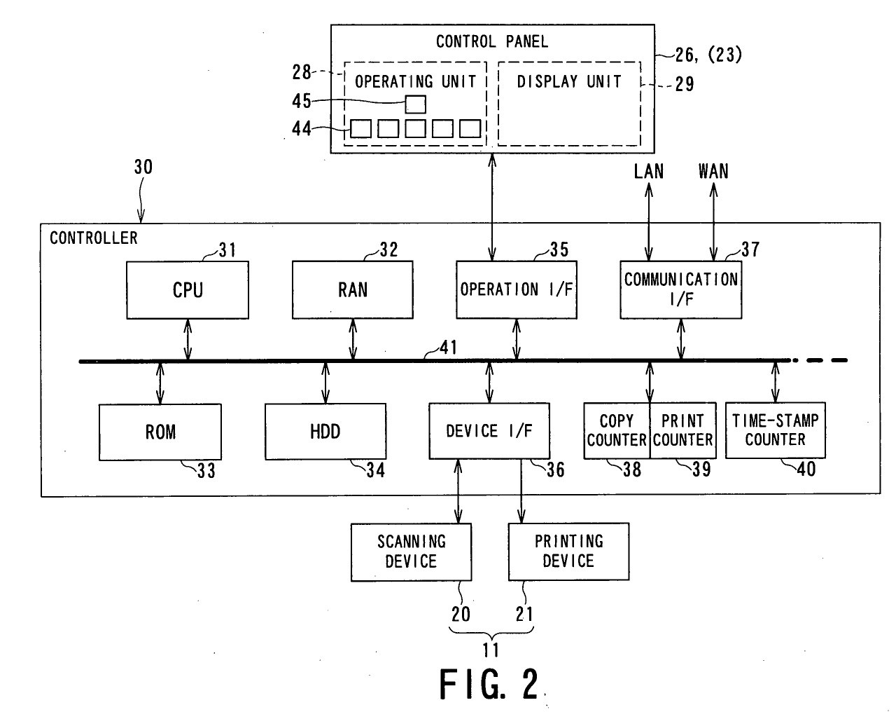

A main body of the MFP 11 is provided with a PC 25 for communicating with the MFP 11. The PC 25 includes a control panel 26 of a touch-panel type. As shown in FIG. 2, the control panel 26 includes an operating unit 28 constituting an input section and a display unit 29 constituting an output section, and serves as, for example, a user interface with the MFP 11 and as a remote control for the MFP 11. The display unit 29 is, for example, a liquid crystal display or an organic EL display.

The scanning device 20 of the MFP 11 includes a controller 30 for controlling the startup of the entire MFP 11. The controller 30 controls the operation of the scanning device 20 and printing device 21 in response to the operation of the control panel 26.

The controller 30 includes a CPU (MPU) 31 serving as a central processing control unit for controlling the entire MFP 11, a RAM 32 serving as a work memory used by the CPU 31 and as a temporary memory for scanned document data (image data), a ROM 33 on which an operation program of the MFP 11 is stored, a hard disk 34, an operation interface (I/F) 35 connected to the control panel 26, a device I/F 36 connected to the scanning device 20 and to the printing device 21, a communication I/F 37 connected to the system bus 17 and to the communication network 18, a copy counter 38 for counting the number of copies from the printing device 21, a print counter 39 for counting the number of sheets printed by operating a PC, and a time-stamp counter 40 for counting the number of times a time stamp is used. All the above-described components of the controller 30 are connected via a control bus 41.

System software to be executed by the CPU 31, scan settings configured by a user, scanned document data, and the like are stored on the hard disk 34. The operation I/F 35 is an interface with the control panel 26. The operation I/F 35 outputs, to the control panel 26, image data to be displayed on the control panel 26, while sending information entered by the user from the operating unit 28 to the CPU 31 of the controller 30.

The communication I/F 37 is an interface with the LAN and communication network (WAN). The device I/F 36 is an interface with the scanning device 20 and printing device 21 that serve as input/output devices for scanned document data.

The copy counter 38 is for counting the number of copies of scanned document data printed by the printing device 21. The print counter 39 is for counting the number of sheets on which document data (including graphics data) is printed by operating a PC connected via the LAN to operate the printing device 21.

The time-stamp counter 40 is for counting the number of times a time stamp is added to scanned document data created by the scanning device 20.

A plurality of scan buttons 44 on the control panel 26 for controlling the MFP 11 are used to display a scan template (not shown) on the display unit 29 of the control panel 26. The scan template defines items necessary for storing documents in accordance with company's (user's) rules and legal regulations.

The scan template defines scan settings, filing settings, optical character recognition (OCR) settings, security settings, or the like that are required for converting images of paper documents into electronic form.

The control panel 26 (23) of the MFP 11 provides scan buttons 44 that reflect the scan template. Settings for storing documents are configured in the scan template by using the scan buttons 44. This reduces time required for the user to perform a series of operations that involve the creation of scanned document data, electronic signing, time stamping, and the storing of scanned document data files.

The operating unit 28 of the control panel 26 provides an electronic certificate system 45 that is used to specify users who can use the MFP 11 and to restrict access to the MFP 11 by the other users. The users who are permitted to use the MFP 11 are pre-registered in the certificate system 45. Only the permitted users and an administrator who has configured the certificate settings have access to the MFP 11. Users who are not pre-registered in the certificate system 45 cannot use the MFP 11. Information of each registered user includes the name of a department the user belongs to.

As described above, the operating unit 28 of the control panel 26 provides the certificate system 45 for specifying users who can access the MFP 11 and the extent to which each user can use the MFP 11. Since the certificate system 45 thus gives permission for the use of the MFP 11 and defines the range of use, a problem of easy and unauthorized use of a time stamp and electronic signature can be avoided. Examples of certificate methods used in the certificate system 45 to certificate individual users include biometrics such as finger scans, password certificate, and contact-type card certificate through ID cards or the like.

Pressing the plurality of scan buttons 44 on the control panel 26 (23) causes the scanning device 20 to operate. The MFP 11a, which is one of the MFPs 11 installed in an organization (company), will be mainly described below.

The scanning device 20 converts images of documents required to be kept under company's rules and legal regulations into electronic form, and creates scanned document data. Examples of documents that are required to be kept include contract documents, approval documents, project proposals, and receipts.

Scanned document data 50 created by the scanning device 20 is stored in a data memory, such as the RAM 32, or printed by the printing device 21. The number of copies of the scanned document data 50 printed by the printing device 21 is counted by the copy counter 38. The number of sheets printed by operating other PCs (not shown) connected via the LAN to the printing device 21 is counted by the print counter 39.

The scanned document data 50 created by the scanning device 20 of the MFP 11a is sent, as necessary, via the communication network 18 to the time-stamping server 15 or to the electronic signature server 16, where a time stamp is given or an electronic signature is verified. In consideration of the amount of data and time required for data transmission, a hash value of the scanned document data 50 is calculated and used for communication between the scanning device 20 of the MFP 11a and the time-stamping server 15 or electronic signature server 16. Software designed for electronic signing (hereinafter may be referred to as “electronic signature software”) is used to add an electronic signature to the hash value.

After the hash value of the scanned document data 50 is given a time stamp or an electronic signature, the scanned document data 50 is combined with the time stamp or with the electronic signature using the electronic signature software to form time-stamped/electronically-signed scanned document data 51. Tampering with documents can thus be effectively prevented by adding a time stamp or an electronic signature to the scanned document data 50.

The time-stamped/electronically-signed scanned document data 51 can be displayed on the display unit 29 of the control panel 26 (23) by operating the control panel 26 (23).

Moreover, the time-stamped/electronically-signed scanned document data 51 can be sent to the document management server 14 by operating the control panel 26 (23), given a retrieval key by the document management server 14, and stored on a hard disk of the document management server 14.

In addition to having a function of storing the time-stamped/electronically-signed scanned document data 51, the document management server 14 has a version management function, a retrieval function, and a verification function in which a time stamp or electronic signature of the time-stamped/electronically-signed scanned document data 51 stored on the document management server 14 is verified.

The time-stamped/electronically-signed scanned document data 51 stored on the document management server 14 can be accessed by the administrative PC 12, searched with the retrieval key by operating the administrative PC 12, and freely viewed. Moreover, the time-stamped/electronically-signed scanned document data 51 can be printed by the printing device 21 of the MFP 11a.

To add a time stamp and an electronic signature to the scanned document data 50, a client organization, such as a company, makes licensing agreements with a timing authority providing the time-stamping server 15 and with a certificate authority providing the electronic signature server 16. Only licensed MFPs 11 (11a, 11b, and 11c) in the client organization have access to the time-stamping server 15 and electronic signature server 16, and can be given a time stamp and electronic signature.

In general, an agreement made between a client and a certificate authority is a package agreement for a specified duration. Therefore, the client can receive an electronic signature any time and an unlimited number of times within the duration of the agreement by using electronic signature software. No fee is charged each time the client receives the electronic signature.

On the other hand, under an agreement made between a client and a timing authority, for example, a fee is charged on an as-used basis in addition to the basic fee. That is, the usage fee is charged every time the client uses a time stamp. For example, the agreement limits the number of times the client can use the time stamp to 10000 times. In this case, the agreement must be renewed if the total number of times the MFPs 11a, 11b, and 11c of the client can use the time stamp has exceeded the limit. If the total number of times has exceeded the limit, the MFPs 11a, 11b, and 11c of the client become no longer able to receive the time stamp from the time-stamping server 15.

Therefore, to manage a time-stamp licensing agreement and associated costs in a client organization (such as a company), it is important to count and manage the number of times a time stamp is used in each of the MFPs 11a, 11b, and 11c of the departments A, B, and C.

In this device management system 10, each of the MFPs 11a, 11b, and 11c includes the scanning device 20 with the time-stamp counter 40 for counting the number of times the scanning device 20 uses the time-stamping server 15. The time-stamp counter 40 is included in the controller 30 controlled by operating the control panel 23 of the scanning device 20 or by operating the control panel 26 of the PC 25.

The time-stamp counter 40, the copy counter 38, and the print counter 39 that are included in the controller 30 are connected through the communication I/F 37 via the LAN to the administrative PC 12.

Every time a user uses the time-stamping server 15 to add a time stamp to the scanned document data 50 created by the scanning device 20, the time-stamp counter 40 of the scanning device 20 used by the user is incremented. That is, the time-stamp counter 40 for a department to which the user having used the MFP 11a belongs is incremented.

Similarly, in each of the MFPs 11b and 11c used by the departments B and C, respectively, the time-stamp counter 40 in the scanning device 20 is incremented every time a user belonging to the department uses a time stamp.

Moreover, the copy counter 38 and print counter 39 in each of the MFPs 11a, 11b, and 11c count the number of copies and the number of printed sheets, respectively.

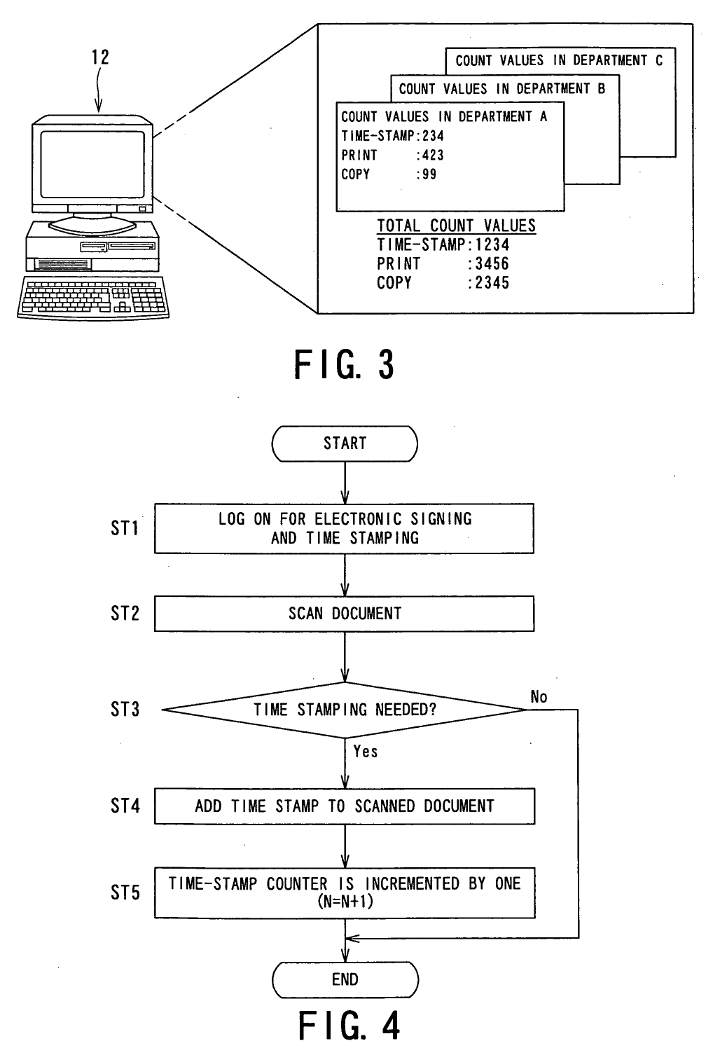

The number of copies, the number of printed sheets, and the number of times a time stamp is used are counted by the copy counter 38, the print counter 39, and the time-stamp counter 40, respectively, in each of the MFPs 11a, 11b, and 11c for the departments A, B, and C, sent via the communication I/F 37 of the controller 30 to the administrative PC 12, and managed, as shown in FIG. 3, both individually for each of the departments A, B, and C and collectively. Thus, in an administrative section of the organization (company), a system administrator uses the administrative PC 12 to read the total count value, and collectively manage the number of times the MFPs 11 (11a, 11b, and 11c) for the departments A, B, and C are used.

The accounting PC 13 for an accounting section of the company receives data from the administrative PC 12, and collectively manages the copy counter 38, print counter 39, and time-stamp counter 40 for each of the departments A, B, and C, thereby sharing costs among the departments A, B, and C according to the count values of the copy counter 38, print counter 39, and time-stamp counter 40.

When an organization, such as a company, is under a time-stamp licensing agreement with a timing authority, and if the maximum number of times the time stamp can be used (number of licenses purchased by the organization) has been exceeded, all the departments A, B, and C and users within the organization become no longer able to add the time stamp to the scanned document data 50 created by each scanning device 20 until licenses are purchased again.

However, in the device management system 10 of the present invention, the scanning device 20 of each of the MFPs 11 (11a, 11b, and 11c) includes the time-stamp counter 40 connected via the LAN to the administrative PC 12. Thus, the administrative PC 12 reads and collectively manages the count value of each time-stamp counter 40.

Therefore, when there are remaining time stamp licenses, the administrative PC 12 collectively manages the number of remaining licenses and notifies the accounting PC 13 for the accounting section that the number of remaining licenses has reached a certain value, well before the expiration of the licenses. Then, if the accounting section authorizes the administrative section to purchase (renew) the licenses, the administrative section renews the licensing agreement with the timing authority. The administrative section notifies the MFPs 11a, 11b, and 11c used in the respective departments A, B, and C that the agreement with the timing authority has been renewed, and displays, on the control panel 23 (26) for each of the MFPs 11a, 11b, and 11c, a message indicating that the agreement with the timing authority has been renewed.

The operation of the device management system 10 will now be described.

Examples of documents required to be kept in each of the departments A, B, and C under the company's (client's) rules and legal regulations include contract documents, approval documents, project proposals, and receipts. Each MFP 11 converts images of these documents into electronic form to create the scanned document data 50, including graphics data.

A hash value for the purpose of data transmission is calculated by the CPU 31 of the controller 30 on the basis of the created scanned document data 50, and sent via the communication network 18 to the time-stamping server 15. The hash value of the scanned document data 50 is given a time stamp by the time-stamping server 15 while given an electronic signature by electronic signature software.

A time stamp is intended to certify the time certificate of the scanned document data 50, while an electronic signature is intended to certify under whose responsibility the certificate of the existence of the scanned document data 50 is issued. The individual users to be certified are pre-registered in the certificate authority.

After being given a time stamp and an electronic signature by the time-stamping server 15 and electronic signature server 16, respectively, the hash value of the scanned document data 50 is sent back to the controller 30 of the MFP 11, and attached to and combined with the scanned document data 50.

Then, the time-stamped/electronically-signed (certificated) scanned document data 51 is sent from the controller 30 of the MFP 11 to the document management server 14, registered as an image document on the hard disk of the document management server 14, given a retrieval key, and stored on the hard disk.

When the time-stamped/electronically-signed scanned document data 51 is stored, its time stamp and electronic signature are verified and a search function is added to the document management server 14.

Each scanning device 20 of the MFPs 11a, 11b, and 11c used by the respective departments A, B, and C includes the copy counter 38, print counter 39, and time-stamp counter 40 for counting the number of copies produced by using the printing device 21, the number of printed sheets from the printing device 21, and the number of times a time stamp is received from the time-stamping server 15, respectively.

The count values of the copy counter 38, print counter 39, and time-stamp counter 40 in the controller 30 for each scanning device 20 are sent via the LAN to the administrative PC 12 and collectively and comprehensively managed by the administrative PC 12.

The time-stamp counter 40 in the scanning device 20 used in each of the departments A, B, and C is controlled by the CPU 31 in the controller 30, and performs counting operation as shown in the flowchart in FIG. 4.

In step ST1, a user logs on to one of the MFPs 11 (11a, 11b, and 11c) for electronic signing and time stamping. In step ST2, the user uses the control panel 26 (23) to cause the scanning device 20 to perform scanning operation.

The scanning device 20 reads and converts a document image into electronic form, thereby creating the scanned document data 50.

In step ST3, it is determined, automatically by the CPU 31 of the controller 30 or manually by operating the control panel 26 (23), whether or not the scanned document data 50 created by the scanning device 20 is to be given a time stamp by the timing authority.

If a time stamp is to be added to the scanned document data 50, the process proceeds to step ST4 where the time-stamping server 15 adds a time stamp to the scanned document data 50 via a hash value.

The time-stamp counter 40 is incremented by one every time a time stamp is added to the scanned document data 50. The count value of the time-stamp counter 40 is sent via the LAN to the administrative PC 12 and comprehensively and collectively managed by the administrative PC 12.

The administrative PC 12 collects the count value of the time-stamp counter 40 in each of the MFPs 11a, 11b, and 11c within an organization (company) and collectively manages the number of times the time-stamping server 15 is used.

If it is determined in step ST3 that there is no need to add a time stamp from the time-stamping server 15 to the scanned document data 50, steps ST4 and ST5 are bypassed. In this case, the time-stamp counter 40 does not operate and no counting operation is performed.

As described above, the device management system 10 of the present invention not only allows counting of the numbers of copies and printed sheets from the printing device 21, but also allows the time-stamp counter 40 in each scanning device 20 to count the number of times a time stamp is used. Then, the numbers of copies and printed sheets, and the number of times a time stamp is used that are counted in the individual MFPs 11 in the respective departments A, B, and C can be collectively managed by the administrative PC 12. While the MFPs 11 are placed in the respective three departments A, B, and C in the embodiment described above, the number of places where the MFPs 11 are placed is not limited to three.

The count values of the copy counter 38, print counter 39, and the time-stamp counter 40 are collectively managed and sent by the administrative PC 12 to the accounting PC 13, where costs are shared among the departments A, B, and C. The accounting PC 13 can collectively and comprehensively manage the overall costs and ease cost management, such as cost sharing.

While the administrative PC 12 and the accounting PC 13 are separate in the device management system 10 of the embodiment described above, the administrative PC 12 and the accounting PC 13 may combine to form a single PC.

In the device management system 10 of the embodiment described above, the MFP 11s are connected to the time-stamping server 15 via the communication network 18, such as the Internet. However, the time-stamping server 15 may be installed within the company, and the MFP 11s are connected to the time-stamping server 15 via a LAN.

The degrees of importance of documents required to be kept under legal requirements and company's (private) rules vary. Therefore, documents with higher importance may be selected such that they are signed by the time-stamping server 15 and electronic signature server 16 provided by (public) third-party organizations that are highly reliable.

What is claimed is:

1. A device management system comprising:
one or a plurality of scanning devices for reading and converting a document image of a contract document, an approval document, a receipt, or the like into electronic form to generate scanned document data;
a time-stamping server for adding a time stamp to the scanned document data;
a time-stamp counter included in each of the scanning devices for counting the number of times the time stamp is used;
a document management server for receiving and storing the time-stamped scanned document data;
a control panel for causing one of the scanning devices to perform scanning operation; and
an administrative PC connected to each of the scanning devices and collectively managing the number of times the time stamp is used by the scanning devices.

2. The device management system according to claim 1, wherein one or the plurality of scanning devices are provided in an organization, such as a company, that includes one or a plurality of departments, branches, and employees.

3. The device management system according to claim 1, wherein each of the scanning devices is included in a multi-functional peripheral with a printing device, and includes a copy counter and a print counter as well as the time-stamp counter.

4. The device management system according to claim 1 or 3, wherein each of the scanning devices includes a controller controlled by operating the control panel, and the controller includes the time-stamp counter, a copy counter, and a print counter.

5. The device management system according to claim 1, wherein the administrative PC is connected via a LAN to an accounting PC, and time-stamp usage information collectively managed by the administrative PC is sent to the accounting PC.

6. The device management system according to claim 1, wherein the administrative PC and an accounting PC combine to form a single PC connected via a LAN to one or the plurality of scanning devices provided in each department of an organization.
